(19) United States
(12) Patent Application Publication
(10) Pub. No.: US 2020/0126687 A1
(43) Pub. Date: Apr. 23, 2020

(54) ELECTRIC CABLE HAVING A PROTECTING LAYER

(71) Applicant: PRYSMIAN S.p. A., Milan (IT)

(72) Inventors: Alberto BAREGGI, Milan (IT); Paolo MAIOLI, Milan (IT); Armando Michele FERRARI, Milan (IT)

(73) Assignee: PRYSMIAN S.p. A., Milan (IT)

(21) Appl. No.: 16/472,952

(22) PCT Filed: Dec. 27, 2016
(86) PCT No.: PCT/IB2016/058011

§ 371 Date: Jun. 24, 2019

(51) Int. Cl. H01B 7/28; H01B 7/02; H01B 3/44

(52) U.S. Cl. CPC H01B 7/28; H01B 3/20; H01B 3/441; H01B 7/02

(57) ABSTRACT

An electric cable comprising: a cable core having a radius and comprising an electric conductor and an insulating system; a first metal layer in radially outer position with respect to the cable core; and a semiconductive protecting layer between the cable core and the first metal layer. The insulating system comprises an insulating layer based on a propylene copolymer and the protecting layer is made of non-expanded material and has a thickness of from 0.5% to 3% the radius of the cable core. The cable is apt to safely operate at thermal cycles of from 20° C. to at least 90° C. (for example up to 130° C. or more), with substantially no deformation of the metal layer and of the overall cable structure.

The present invention relates to an electric cable, in particular for medium- or high-voltage power transmission or distribution, having a semiconductive protecting layer.

In the present description, the term “medium voltage” (MV) is meant to refer to a voltage of between about 1 kV and about 30 kV, while the term “high voltage” (HV) is meant to refer to voltages above 30 kV.

Cables for MV or HV power transmission or distribution generally consist of a metal conductor coated with a polymeric insulating system composed of an inner semiconductive layer, an insulating layer and an outer semiconductive layer. The cable core comprises the metal conductor plus the insulating system. A metal screen, usually of aluminium or copper, in form of a helically wound tape, of a mesh, of wires or of a foil longitudinally sealed, extruded, overlapped or welded around the cable core, surrounds the outer semiconductive layer.

In some instance, the cable core can be enclosed in a water barrier, usually consisting of an aluminium or copper metal sheet shaped into a tube and longitudinally welded or sealed so as to be watertight.

During its operation the cable is subject to thermal cycles (heating/cooling) as a result of the daily or weekly variations in the intensity of the transported current or in case of short circuit, with corresponding variations in the cable temperature between room temperature (20° C.) and the maximum operating temperature (about 90° C., but even above in case of temporary overload). These thermal cycles cause expansion and subsequent contraction of the coating layers of the cable.

As polymeric materials have thermal expansion coefficients greater than those of metals (from 10 to 40 times greater), the radial forces exerted during thermal cycles by cable polymer layers on the metal layer/s surrounding them can cause deformations of the metal layers and of the cable structure in general. In particular, a metal layer can be radially outwardly stretched and this can not only damage the integrity of the metal layer itself, but also can give place, during a subsequent cooling phase, to empty spaces between the metal layer and the underlying polymeric layer, which may give rise to non-uniformity in the electrical field with risk of cable failure and to impairment of the water barrier system, if any. Also, while a polymeric layer expands during the heating phase, a metal layer in form of mesh or wires can squeeze or even penetrate through the thickness of the underlying polymeric layer/s altering the performance thereof. The greater the cable diameter is, the more severe the possible damages due to the thermal expansion are.

U.S. Pat. No. 6,455,769 relates to a medium- or high-voltage cable comprising a conductor, at least one insulating layer, an outer metal shield and a layer of an expanded polymer material placed under the metal shield, characterized in that the layer of the expanded polymer material is semiconductive and includes a water-swellable material. The thickness of the expanded layer is equal to at least 0.1 mm. The insulating layer is preferably prepared by extrusion of polyethylene, polypropylene, ethylene/propylene copolymers.

EP 0 116 754 relates to high voltage electric power cable adapted to withstand wide swings in temperature. Surrounding the insulation is an insulation shield consisting of a radially inner extruded semiconducting layer of semiconducting material radially spaced from an outer metallic shield between which is interposed a helically wrapped elongated strip of compressible construction. The strips have the ability to deform to fully absorb the radial change in dimensions of the cable during thermal expansion without causing a significant change in the outer diameter of the metallic shield.

The presence of expanded or compressible cushioning layers cause an increasing of the cable diameter and weight. U.S. Pat. No. 6,455,769 exemplifies expanded layers with a thickness of 1 mm and 0.65 mm for cables having, respectively, a core outside diameter of 23 mm and 25.3 mm.

Also, in the Applicant experience, the manufacturing of a semiconductive and expanded layer containing water swellable material is cumbersome and increases the cable cost.

As reported, for example, by D. Tripathi, Practical Guide to Polypropylene, 2002, Rapra Technology Limited, page 3, unmodified polypropylene (PP) has a thermal expansion lower than that of polyethylene, though in the case of high density polyethylene (HDPE) the difference is not outstanding (10×10⁻⁵ for PP vs 12×10⁻⁵ for HDPE).

The Applicant found that in a cable having an insulating layer, a metallic layer and a semiconducting protecting layer, the protecting layer can be non-expanded and can have a reduced thickness (from 1% to 3% of the cable core radius) while ensuring a cable operation with substantially no deformation of the metal layer and of the overall cable structure, with the proviso that the insulating layer is based on a propylene copolymer.

It has been found that, in a cable having an insulation based on a propylene copolymer and a non-expanded semiconductive layer in radially inner position with respect to a metal layer, a thickness of the non-expanded layer of no more than 3% of the radius of the cable core is sufficient to guarantee the cable integrity during thermal cycles.

In particular, it has been found that a cable with the insulating layer based on propylene copolymer can be constructed with a non-expanded protecting layer having a remarkable reduced thickness with respect to the cable core radius, and the cable is apt to safely operate at thermal cycles of from 20° C. to at least 90° C. (for example up to 130° C. or more).

The present invention relates to an electric cable comprising
a cable core having a radius and comprising an electric conductor and an insulating system;
a first metal layer in radially outer position with respect to the cable core; and
a semiconductive protecting layer between the cable core and the first metal layer,

characterized in that the insulating system comprises an insulating layer based on a propylene copolymer and the protecting layer is made of non-expanded material and has a thickness of from 0.5% to 3% the radius of the cable core.

The electric cable is preferably a medium or high voltage cable.

Preferably, the insulating system further comprises an inner semiconductive layer and an outer semiconductive layer provided, respectively, in a radially inner and outer position with respect to the insulating layer and in direct contact with the insulating layer.

Advantageously, the inner semiconductive layer and the outer semiconductive layer are made of a propylene copolymer, preferably the same propylene copolymer as the insulating layer.

The propylene copolymer of the insulating layer or, more extensively, of the insulating system of the cable of the invention is uncrosslinked.

The first metal layer of the cable of the invention is an electric screen in form of a mesh, of wires, of a tape helically wound around the cable core or of a foil longitudinally folded around the cable core and having edges welded or overlapped and sealed, for example, by an adhesive. The first metal layer is preferably of lead, aluminium or copper.

When the first metal layer is in form of a foil longitudinally folded around the cable core it can act as radial water barrier (avoiding the radial water penetration).

In a preferred embodiment, the protecting layer is provided between the outer semiconducting layer and the first metal layer and in direct contact with these layers.

Preferably, the protecting layer is water-swellable in that it can comprise water swellable material, preferably in a subdivided form, particularly in the form of powder. The particles preferably constituting the water-swellable powder have preferably a diameter not greater than 250 μm. More preferably the water-swellable particles have an average diameter of from 10 to 150 μm, preferably of from 30 to 100 μm.

The protecting layer is semiconducting in that it comprises a conductive filler, preferably carbon black, in an amount such as to provide the material of the protecting layer with semiconductive properties, in particular such as to obtain a volume resistance value for the protecting layer material, at room temperature, of less than 10,000 Ω·m, preferably less than 5,000 Ω·m, more preferably less than 1,000 Ω·m as from FNS 19-57-02, Version 3, 2008, Freudenberg. The amount of conductive filler can range between 1 and 50% by weight, preferably between 3 and 30% by weight, relative to the weight of the protecting layer material.

The protecting layer of the cable of the invention is made of non-expanded material.

In the present description and claims, as “non-expanded” it is meant a layer made of a material substantially free from either gas bubbles or gas tunnels incorporated in it, and/or a layer made of a material which does not substantially changes its thickness upon compression.

The protecting layer of the cable of the invention is preferably made of a non-expanded polymeric material, advantageously from non-expanded polyester or polypropylene. In a preferred embodiment of the invention, the protecting layer is made of a nonwoven fabric based on one or more non-expanded polymers. Preferably the protecting layer is in form of a tape helically wounded or longitudinally folded around the cable core.

The thickness of the protecting layer depends upon the radius of the cable core, being from 0.5% to 3% of such radius, preferably from 1% to 2%.

The cable of the present invention can comprise a second metal layer. The second metal layer is preferably provided in a radially outer position with respect to the first metal layer. The second metal layer is preferably made of lead, aluminium or copper and can be in one of the form already mentioned above in connection with the first metal layer.

Preferably, the second metal layer is in form of a foil longitudinally folded around the cable core and can act as radial water barrier.

The cable of the present invention preferably comprises a cushioning layer provided in radial external position with respect to the first metal layer and, if present, in radial internal position with respect to the second metal layer. The cushioning layer is made of a non-expanded material, for example of a polymer material like non-expanded polyester or polypropylene. Optionally, the cushioning layer is a non-expanded, water-swellable layer.

When the cable of the present invention comprises a first metal layer and a second metal layer, the cushioning layer comprised between these metal layers and in direct contact thereto is a non-expanded, semiconductive and, optionally water-swellable layer.

Preferably, the cushioning layer is in form of a tape.

The thickness of the cushioning layer can be substantially the same of that of the protecting layer or can be thinner.

The insulating layer of the cable of the invention is based on a propylene copolymer. Preferably, the copolymer is an ethylene-propylene copolymer. The ethylene-propylene copolymer can be a heterophasic copolymer, a random copolymer or a mixture thereof.

In the present description and claims, with “heterophasic copolymer” it is meant a copolymer in which elastomeric domains are dispersed in a polymer matrix. Preferably, the heterophasic copolymer of the invention has ethylene-propylene elastomer (EPR) as elastomeric domains dispersed in a propylene copolymer matrix.

Advantageously, the heterophasic ethylene-propylene copolymer for the cable of the invention comprises an elastomeric phase in an amount of from 45 to 85 wt % with respect to the total weight of the copolymer.

Preferably, the insulating layer of the cable of the invention is based on a propylene copolymer admixed with a dielectric fluid. The amount of dielectric fluid is preferably of from 1 wt % to 10 wt %, more preferably of from 3 wt % to 7 wt %.

Advantageously, the dielectric fluid has a predetermined viscosity in order to prevent fast diffusion of the liquid within the insulating layer and hence its outward migration, as well as to enable the dielectric fluid to be easily fed and mixed into the thermoplastic polymer material. Generally, the dielectric fluid of the invention has a viscosity, at 40° C., of from 10 cSt to 800 cSt, preferably of from 20 cSt to 500 cSt (measured according to ASTM standard D445-03).

Examples of suitable dielectric fluids are: aromatic oils, either monocyclic, or polycyclic (condensed or not), wherein aromatic moieties can be substituted by at least one alkyl group C₁-C₂₀, and mixtures thereof. When two or more cyclic moieties are present, such moieties may be linked by an alkenyl group C₁-C₅.

Suitable material for the insulating layer of the cable of the invention are disclosed, e.g., in WO 02/03398, WO 02/27731, WO 04/066318, WO 07/048422 and WO 08/058572.

The inner semiconducting layer and the outer semiconducting layer of the cable of the invention are preferably made of substantially the same material as the insulating layer from which they differ in that they contains a conducting filler similar to that mentioned in connection with the composition of the semiconducting protecting layer.

For the purpose of the present description and of the appended claims, the words “a” or “an” are used to describe elements and components of the invention. This is done merely for convenience and to give a general sense of the invention. This description and claims should be read to include one or at least one and the singular also includes the plural unless it is obvious that it is meant otherwise.

For the purpose of the present description and of the appended claims, except where otherwise indicated, all numbers expressing amounts, quantities, percentages, and so forth, are to be understood as being modified in all instances by the term “about”. Moreover, all ranges include any combination of the maximum and minimum points disclosed and include any intermediate ranges therein, which may or may not be specifically enumerated herein.

Further characteristics will be apparent from the detailed description given hereinafter with reference to the accompanying drawing, in which:

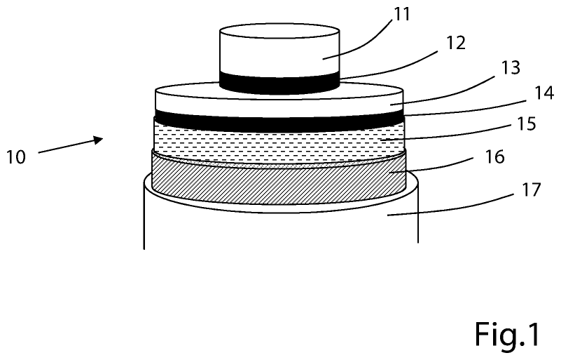

FIG. 1 shows a cross-section of an embodiment of an electrical cable according to the present invention;

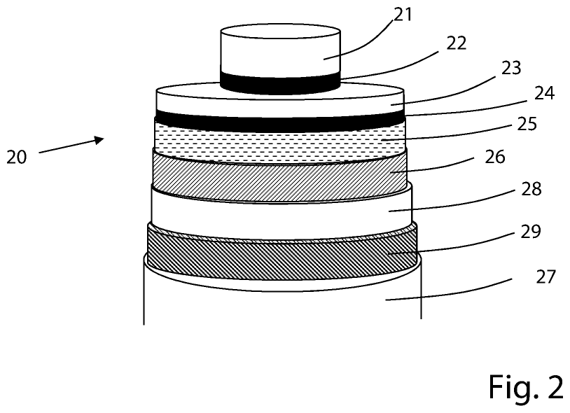

FIG. 2 shows a cross-section of another embodiment of an electrical cable according to the present invention.

The cable (10) of FIG. 1 is a single core cable comprising a conductor (11) sequentially surrounded by an inner layer semiconducting layer (12), an insulating layer (13) and an outer semiconducting layer (14), these three layers constituting the insulating system. All of the layers of the insulating system are made of a propylene copolymer.

The outer semiconducting layer (14) is surrounded by and in contact with a semiconducting, water-swellable and non-expanded protecting layer (15) which, in turn, is surrounded by and in contact with a first metal layer (16). In the present embodiment, the first metal layer (16) is in form of a longitudinally welded aluminium foil and acts as electric screen and as radial water barrier.

An outer sheath (17), in polymeric material, e.g. HDPE, is the outermost layer.

The cable (20) of FIG. 2 is a single core cable comprising a conductor (21) sequentially surrounded by an inner semiconducting layer (22), an insulating layer (23) and an outer semiconducting layer (24), these three layers constituting the insulating system. All of the layers of the insulating system are made of a propylene copolymer.

The outer semiconducting layer (24) is surrounded by and in contact with a semiconducting, water-swellable and non-expanded protecting layer (25) which, in turn, is surrounded by and in contact with a first metal layer (26). In the present embodiment, the first metal layer (26) is in form of helically wound copper wires and acts as electric screen.

Cable (20) further comprises a second metal layer (29) and a semiconductive and non-expanded cushioning layer (28) in a radially internal position. Due to its semiconductive property, the cushioning layer (28) is suitable for establishing an electric contact between the first metal layer (26) and the second metal layer (29).

The second metal layer (29) is in form of a longitudinally welded aluminium foil and acts as electric screen and as radial water barrier.

An outer sheath (27), in polymeric material, e.g. HDPE, is the outermost layer.

### EXAMPLE 1

Thermal expansion of high voltage cables was calculated at temperature increasing from 20° C. to 130° C.

Two samples of cable cores 300 mm long have been tested, the samples having the following features:

Sample 1 (comparative):
1200 mm² Al conductor (diameter: 43 mm)
2.1 mm inner semiconducting layer
21.2 mm insulating layer
1.6 mm outer semiconducting layer

The insulating layer was made of crosslinked low density polyethylene (LDPE), while the semiconducting layers were made of crosslinked ethyl butyl acetate (EBA).

The outer diameter was of about 93 mm.

Sample 2 (according to the invention):
1000 mm² Cu conductor (diameter: 40 mm)
1.4 mm inner semiconducting layer
16.8 mm insulating layer
1.1 mm outer semiconducting layer

The insulating system was made of a mixture 75:25 of, respectively, a heterophasic ethylene-propylene copolymer having about 70 wt % of elastomeric phase and a random ethylene propylene copolymer, the mixture being admixed with 6 wt % of dibenzyltoluene.

The outer diameter was of about 79 mm.

Preliminary heating cycles up to 130° C. and return to ambient temperature were carried out to allow shrink back and stabilize insulation length. The thermal expansion was calculated as percentage of the thickness of the insulating layer. The temperatures are measured on the conductor.

TABLE 1

| Temprature | Thermal expansion (%) | Thermal expansion (%) |
|---|---|---|
| (° C.) | Sample 1* | Sample 2 |
| 20 | 0 | 0 |
| 50 | 2 | 1.8 |
| 70 | 3.4 | 2.3 |
| 90 | 5.4 | 3.9 |
| 110 | 8.2 | 4.4 |
| 130 | 9.8 | 5.9 |

The cable core according to the invention has a thermal expansion percentage of its diameter much lower than a cable core having an insulating system based on crosslinked polyethylene.

It has to be noted that at temperatures greater than 90° C., the insulating layer based on crosslinked polyethylene suffered from a drop of hardness (Shore D hardness from 30 after 15 seconds at 90° C. to 0 after 15 seconds at 110° C.) and this prevents the use of this cable at temperature greater than 130° C. (on the conductor). Adversely, in a cable according to the invention, the insulating layer had a Shore D hardness decreasing from 40 after 15 seconds at 90° C. to about 26 after 15 seconds at 130° C.; accordingly, such a hardness drop value is compatible with an acceptable cable performance at 130° C. operating temperature and up to 150° C. or more on the conductor (with a thermal expansion which still remains within limits acceptable for cable integrity).

### EXAMPLE 2

A cable according to the invention having
insulating system made of a mixture 75:25 of, respectively, a heterophasic ethylene-propylene copolymer having about 70 wt % of elastomeric phase and a random ethylene propylene copolymer, the mixture being admixed with 6 wt % of dibenzyltoluene,
cable core outer diameter of 78 mm,
a semiconducting, water-swellable and non-expanded protecting layer made of a polyester nonwoven fabric tape having a thickness of 0.5 mm (1.3% of the cable core radius), and
a first metal layer in form of a longitudinally welded aluminium foil having a thickness of 1 mm,
   was tested under repeated thermal cycles according to IEC 62067-01 (2001-10) and successfully passed them (no deformation of the first metal layer was detected).

A comparative cable having the insulating layer made of cross-linked polyethylene, a cable core outer diameter of 78 mm and a first metal layer in form of a longitudinally welded aluminium foil having a thickness of 1 mm, did not pass the test according to IEC 62067-01 (2001-10) with a semiconducting, water-swellable and non-expanded protecting layer made of a polyester nonwoven fabric tape having a thickness of 0.78 mm (2% of the cable core radius).

In particular, the repeated thermal cycles caused a plastic deformation of the first metal layer such that, after a cooling step and the relevant cable layer contraction, discontinuities were formed at the interface between the first metal layer and the outer semiconducting layer. Such discontinuities gave place to lack of electrical contact between the metal layer and the underlying outer semiconducting layer, such that sparks have been observed, thereby compromising the electrical performance of the cable; in addition, the presence of such discontinuities compromised also the longitudinal water barrier performance of the protecting layer.

1. Electric cable comprising
a cable core having a radius and comprising an electric conductor and an insulating system;
a first metal layer in radially outer position with respect to the cable core; and
a semiconductive protecting layer between the cable core and the first metal layer,
characterized in that the insulating system comprises an insulating layer based on a propylene copolymer and in that the protecting layer is made of non-expanded material and has a thickness of from 0.5% to 3% of the cable core radius.

2. Electric cable according to claim 1 wherein the insulating system comprises an inner semiconductive layer and an outer semiconductive layer provided, respectively, in a radially inner and outer position with respect to the insulating layer and in direct contact with the insulating layer, and the inner semiconductive layer and an outer semiconductive layer are made of a propylene copolymer.

3. Electric cable according to claim 2 wherein the protecting layer is provided between the outer semiconducting layer and the first metal layer and in direct contact with these layers.

4. Electric cable according to claim 1 wherein the protecting layer is water swellable.

5. Electric cable according to claim 4 wherein the protecting layer comprises water swellable powder constituted by particles having an average diameter of from 10 to 150 μm.

6. Electric cable according to claim 1 wherein the protecting layer is made of a nonwoven fabric based on one or more non-expanded polymer.

7. Electric cable according to claim 1 wherein the protecting layer is in form of a tape helically wounded or longitudinally folded around the cable core.

8. Electric cable according to claim 1 wherein the thickness of the protecting layer is of from 1% to 2% of the cable core radius.

9. Electric cable according to claim 1 comprising a second metal layer in a radially outer position with respect to the first metal layer.

10. Electric cable according to claim 1 comprising a cushioning layer provided in radial external position with respect to the first metal layer, the cushioning layer is made of a non-expanded material.

11. Electric cable according to claim 1 comprising a second metal layer and a non expanded and semiconductive cushioning layer provided in radial external position with respect to the first metal layer in radial internal position with respect to the second metal layer.

12. Electric cable according to claim 1 wherein the propylene copolymer is an ethylene-propylene copolymer.

13. Electric cable according to claim 12 wherein the ethylene propylene copolymer is a heterophasic copolymer, a random copolymer or a mixture thereof.

14. Electric cable according to claim 13 wherein the heterophasic ethylene-propylene copolymer for the cable of the invention comprises an elastomeric phase in an amount of from 45 to 85 wt % with respect to the total weight of the copolymer.

15. Electric cable according to claim 1 wherein the propylene copolymer is admixed with a dielectric fluid in an amount of from 1 wt % to 10 wt %.
